(19) United States
(12) Patent Application Publication
(10) Pub. No.: US 2003/0218971 A1
(43) Pub. Date: Nov. 27, 2003

(54) Compact disc surface guard and method and device for forming

(76) Inventor: Duane A. Rhodes, Arlington, TX (US)

Correspondence Address: LITTMAN LAW OFFICES, LTD., P.O. BOX 15035 CRYSTAL CITY STATION, ARLINGTON, VA, 22215, US

(21) Appl. No.: 10/151,931

(22) Filed: May 22, 2002

(51) Int. Cl. G11B 23/03

(52) U.S. Cl. 369/291

(57) ABSTRACT

A compact disc surface guard, a method of attaching the guard, and a base device for attaching an optically clear plastic shield in the shape of a compact disc (CD) which is adhesively applied to a CD such as CD random read only memory devices (ROMs) and digital video discs (DVD's) through the use of a self-centering applicator device. The shield can be readily removed from the CD. A kit provides the necessary materials and an instruction sheet.

### BACKGROUND OF THE INVENTION

1. Field of the Invention

The present invention relates generally to protective coverings. More specifically, the invention is an optically clear, translucent polycarbonate shield in the shape of a compact disc (CD) which is adhesively applied to compact discs (CD) such as CD random read only memory devices (ROMs) and digital video discs (DVD's) through the use of a novel self-centering applicator device.

2. Description of the Related Art

The relevant art of interest describes various methods and devices for forming a compact disc cover, but none describes the present invention. There is a need for an inexpensive device to hold and center the compact disc for the application of a cover such as a polycarbonate shield. The adhesive can be readily removed without damaging the disc. The related art will be discussed in the order of perceived relevance to the present invention.

U.S. Pat. No. 4,879,710 issued on Nov. 7, 1989, to Mutsuo Iijima describes a 0.125 mm. thick optical disc protector and a method for applying the protector comprising a transparent annular sheet of cellulose triacetate having an inner ring of adhesive and an outer ring of adhesive applied to either or both sides. If applied to the data-read side, the adhesive rings are disposed on the disc so as not to obscure the data region. A centering adapter device comprises a circular shoulder slightly smaller in diameter than the hole of the disc protector, and a bulbous bottom having a diameter to fit the compact disc's hole. The package of the compact disc protector with a top and bottom adhesively attached secondary tabbed peelable protector layers have the bottom tabbed protector layer removed, the disc protector placed over the centering adapter device, and pushed down until the protector layer is on the compact disc to be held by the adhesive layer, and the top secondary protector layer is removed to complete the process of adding the disc protector. The product is distinguishable for requiring top and bottom protective layers. The centering adapter device is distinguishable for its shoulder and bulbous end. The reference is silent as to the compositions of the adhesive and tabbed protective layers.

U.S. Pat. No. 4,983,437 issued on Jan. 9, 1991, to Steven L. Merrick describes a thin, flat, polymer, scratch resistant, user applied disc protector with self-adhesive backing which affixes to the top of a compact disc to help eliminate possible damage from impact. This extra layer of user applied protection is prefabricated to proper size by precutting to adhesively secure with a self-adhesive layer by application of adhesive on the top side of the disc by the user in one embodiment. The disc protector can have a removable peel-away backing over an adhesive layer in anther embodiment. 1-20 mils of a transparent or opaque layer of polycarbonate, polyester, polyethylene, polypropylene or kapton can be applied over an optional ultraviolet light protecting colored layer, an acrylic adhesive, and a peel-away backing. The disc protector is distinguishable for requiring the user to fit the protector layer without the aid of any apparatus.

U.S. Pat. No. 6,240,061 B1 issued on May 29, 2001, to Trevor A. Burroughs describes a semi-permanent enclosure for an optical data storage device comprising a polyvinyl chloride or rubberized silicone layer as an optical couplant for a polycarbonate, acrylic resin or cellulose acetate shield with a lower rim metal component. The device is distinguishable for requiring an optical couplant layer for the shield component.

U.S. Pat. No. 5,912,875 issued on Jun. 15, 1999, to Michael D. Lowe et al. describes an apparatus for applying a removable protective cover such as polyester or polycarbonate, e.g, Lexan (TM) to a circular apertured optical disc. The process of making is distinguishable because a waffle-maker type apparatus with clasps is required.

U.S. Pat. No. 6,318,436 B1 issued on Nov. 20, 2001, to Michael Hummell et al. describes an apparatus for applying labels on optical discs having a base capable of supporting a label over a foam disc and under an optical disc by a plunger element. The base is capable of ultrasonic welding. The apparatus is distinguishable for requiring ultrasonic welding.

U.S. Pat. No. 6,309,727 B1 issued on Oct. 30, 2001, to William Mueller et al. describes a coating of ethylene vinyl acetate applied to the surface of a compact disc precursor which must be protected from dust during manufacture, and the cover is removable. The coating is distinguishable for its different composition and its application as a precursor coating.

U.S. Pat. No. 5,020,048 issued on May 28, 1991, to Yuji Arai et al. describes a compact disc for recording having a protective, hygroscopic, antistatic electricity film formed on the light incident surface comprising polyvinyl alcohol which can be stripped later. The coating is distinguishable for requiring polyvinyl alcohol before recording on a compact disc.

U.S. Reissue Pat. No. 35,947 issued on Nov. 3, 1998, to James J. Kosinski et al. describes a manufactured optical element having a durability enhancing layer between a recording layer over a reflective gold layer and a 2-20 microns of a first spin coated protective layer and a second screen coated layer of at least 3 microns. The compact disc is distinguishable for being a manufactured product.

U.S. Pat. No. 5,935,673 issued on Aug. 10, 1999, to William R. Mueller describes protective coatings for optical discs such as compact discs or digital versatile discs which are surface coated with a removable coating or peel off lacquer when damaged. The coating is distinguishable for being manufactured and consisting of lacquer.

U.S. Pat. No. 6,001,953 issued on Dec. 14, 1999, to Gary C. Davis et al. describes polycarbonate compositions suitable for use in optical articles, and contain residues of other monomers such as 6,6′-dihydroxy-3,3,3′,3′-tetramethylspirobiindane and its derivatives, 2,2-bis(4-hydroxyphenyl) propane, 6-hydroxy-1-(4′-hydroxyphenyl)-1,3,3-trimethylindane, and combinations thereof. The polycarbonate compositions are distinguishable in lacking the addition of a layer of solidified film to cover an optical disc.

U.S. Pat. No. 3,961,656 issued on Jun. 8, 1976, to Lalit K. Aggarwal describes a phonograph record insulator comprising two protector cover members provided with 8 pressure-sensitive adhesive patches on the inner and outer peripheries so that one cover member can be attached to and removed from each side of a record. The covers include spacers to hold the records apart and an electrically conductive layer to help eliminate a static charge buildup. The covers are distinguishable for requiring spacers.

U.S. Pat. No. 4,556,968 issued on Dec. 3, 1985, to Kathleen Pelkey et al. describes an unconstrained removable protective cover for optical disks having a U-shaped unconstrained spacer ring not bonded to the disk. A protective covering is bonded to the top surface of spacer ring, and adhesively bonded to the inner spacer ring. The cover is distinguishable for requiring spacer rings.

U.S. Pat. No. 4,736,966 issued on Apr. 12, 1988, to Richard Haddock et al. describes an optical data storage card with peelable transparent protective layers adhered above the card and made of aclar, Mylar, polyester, and the like. The layers and the card can have a water barrier coating of polytrichlorofluroethylene. The data card covers are distinguishable for requiring a peelable property.

U.S. Pat. No. 5,299,186 issued on Mar. 29, 1994, to Katsuaki Tsurushima describes a removable disc protecting plastic cover consisting of a flat disc having a diameter smaller than the recorded disc and a signal reading surface portion formed on the surface surrounding the center hole. A pronged structure is inserted in the disc's center hole. The cover is distinguishable for requiring its removal before playing the compact disc.

U.S. Pat. No. 5,776,573 issued on Jul. 7, 1998, to J. Morgan Trotter et al. describes a compact disc revitalizer composition or a permanent coating of polycarbonate made by reacting ingredients. The polycarbonate coating is distinguishable for being a permanent coating.

U.S. Pat. No. 6,265,029 B1 issued on Jul. 24, 2001, to William Lewis describes a silane/silica sol copolymer hard-coating composition for protecting optical plastic, wood, metals, and glass. The composition is distinguishable for being limited to an coating composition integrated with a substrate.

None of the above inventions and patents, taken either singularly or in combination, is seen to describe the instant invention as claimed. Thus, an inexpensive compact disc surface guard and a method and an inexpensive device for forming the guard for solving the problems of adequate and safe coverage of CD's, CD ROM's and DVD's is desired.

### SUMMARY OF THE INVENTION

The present invention is essentially an optically clear, translucent, plastic guard in the diecut shape of a compact disc (CD) which is adhesively applied to a CD such as CD random read only memory devices (ROMs) and digital video discs (DVD's) through the use of a novel self-centering applicator device. The guards are pre-mounted on waxed paper with inner and outer peripheral strings of adhesive. The guard can be readily removed without damaging the compact disc. A kit containing several pre-mounted guards on waxed sheets, the mounting or applicator device, and an instruction sheet is contemplated.

Accordingly, it is a principal object of the invention to provide a protective shield or guard for a compact disc, a CD ROM and a digital video disc.

It is another object of the invention to provide a device for applying protective shields on a disc accurately.

It is a further object of the invention to provide a method of applying a diecut protective shield or guard for compact discs, CD ROMs and digital video discs.

Still another object of the invention is to provide a diecut protective shield or guard for a compact disc which can be readily removed without damaging the disc.

Yet another object of the invention is to provide a kit containing multiple guards mounted on waxed papers with peripheral rings of adhesive.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a compact disc surface guard forming jig device according to the present invention.

FIG. 2 is a front elevational view of a square shaped waxed liner having two adhesive rings underneath positioned on a compact disc guard.

FIG. 3 is a cross-sectional view of the pin portion of the jig device with its compression foam element positioned in the base.

FIG. 4 is a perspective view of the pin portion inside the sponge cover with its retractable locking tabs or lugs.

Similar reference characters denote corresponding features consistently throughout the attached drawings.

### DETAILED DESCRIPTION OF THE PREFERRED EMBODIMENT

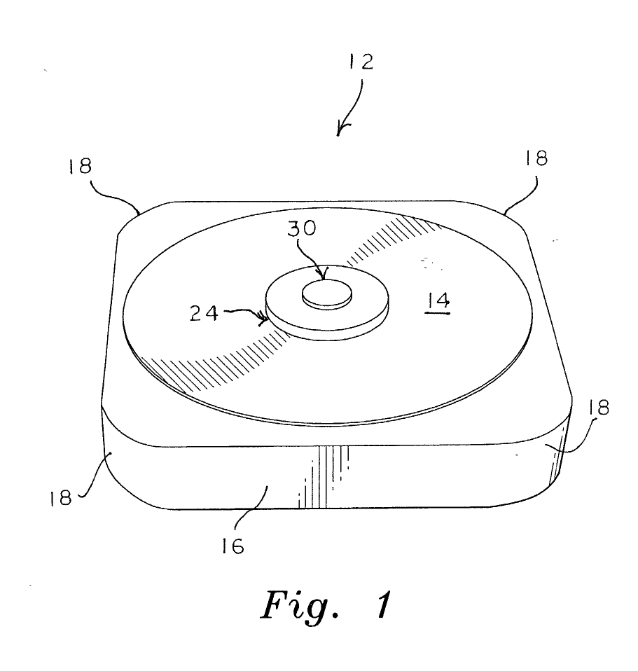

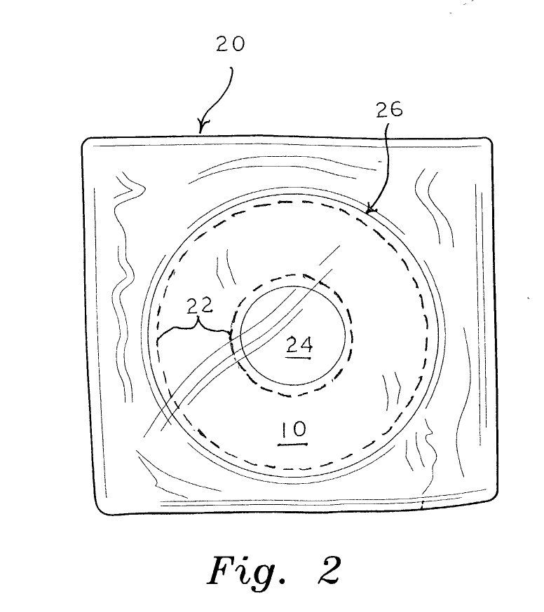

The present invention in FIGS. 1 to 4 is directed to a translucent compact disc (CD) surface guard 10 and a jig device 12 for covering the compact disc 14 efficiently and quickly with the surface guard 10. In FIG. 1, the Precision CD Locator or jig device 12 having a square shaped base 16 with round corners 18 is shown for placing a die cut removable surface guard 10 (FIG. 2) previously placed on a square waxed liner sheet 20 on a compact disc 14 mounted on the jig 12. Peripheral regions of adhesive 22 have been pre-applied on the compact disc 14 adjacent to the center aperture 24 and the outer periphery 26 of the compact disc 14 to adhere the compact disc surface guard 10 to the liner sheet 20 and subsequently to the compact disc 14.

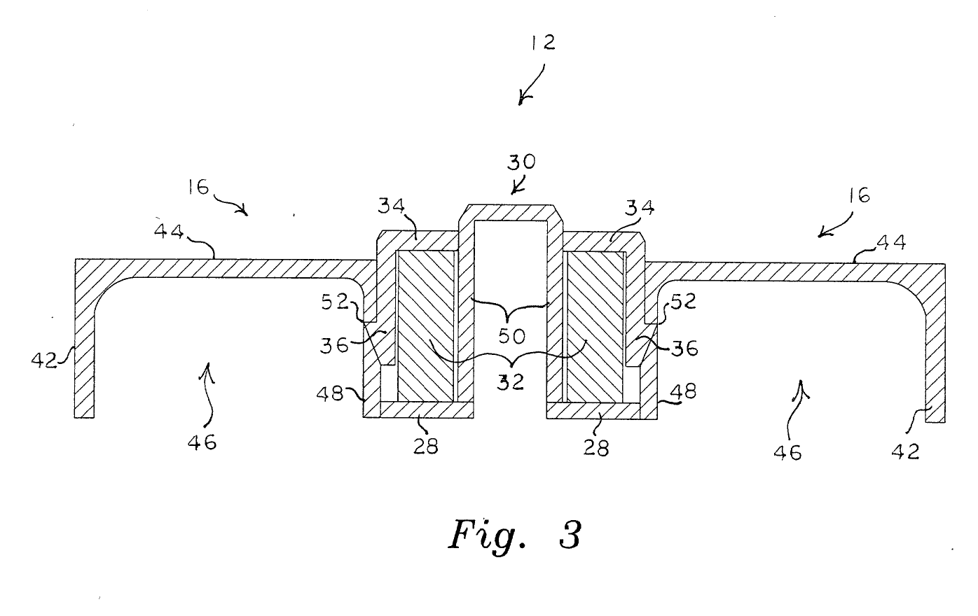

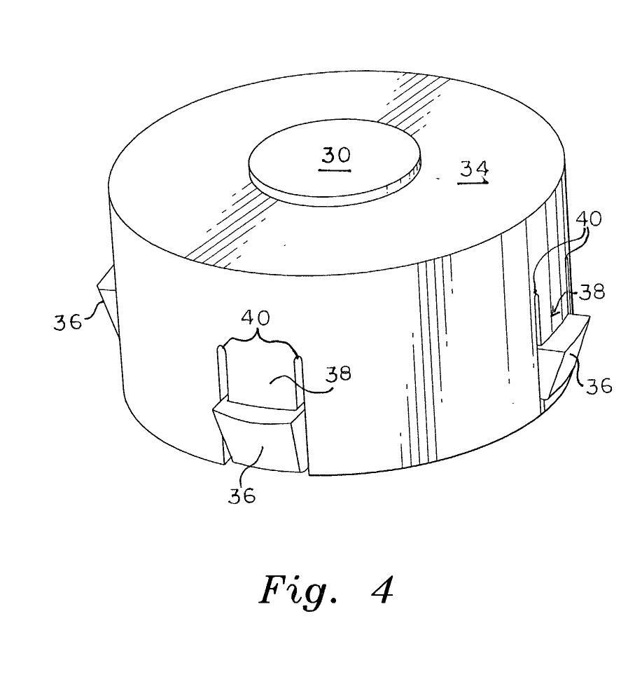

In the cross-sectional view of the jig 12 shown in FIG. 3, jig 12 is a three-piece assembly. The first piece of jig 12 is an approximately square, hollow, plastic base 16 with round corners 18 having a flat centered circular bottom surface 28, and a plastic centered hollow pin portion 30 having a diameter which snugly accepts the circular aperture 24 of any compact disc 14 (FIG. 1). The second piece of jig 12 is a cylindrical polyurethane sponge 32 acting similarly to a coil spring which surrounds the pin portion 30 and is confined within the third piece which is a cover portion 34 which has four keys 36 on extensions 38 spaced 90° apart between grooves 40 (FIGS. 3 and 4).

The square base 16 is substantially hollow as depicted in a cross-sectional view in FIG. 3, having a planar sidewall 42, a planar peripheral top surface 44, a substantially open cylindrical bottom region 46, and a centered cylindrical inner sidewall 48 extending from top to bottom of the base 16. The flat centered circular bottom surface 28 is connected to the inner sidewall 48 and to the cylindrical sidewall 50 of the locator pin portion 30.

The circular inner wall 48 has four keyways 52 equidistantly spaced in its inner portion for securing the locator pin portion 32 in the base 16. The base 16 can alternatively have a circular configuration.

The process of forming the protection of a CD will be now explained. The compact disc surface guard device 10 comprises a translucent, planar, circular sheet of a plastic composition such as either acrylic, polyethylene or polycarbonate, but acrylic is preferred. The sheet 20 is die cut to obtain a compact disc surface guard device 10 having an outer diameter of 4.701 in., a centered circular aperture having a diameter of 1.526 in. and a thickness of 0.005 to 0.10 in. Two thin peripheral adhesive bead rings 22 of pressure sensitive acrylic glue such as “Resin Emulsion” (TM) are added to the outside periphery and the inside periphery of the guard device 10 and placed on a waxed liner sheet 20 as shown in FIG. 2. A plurality of guard devices 10 adhered to waxed liner sheets 20, a mounting jig 12 and instructions for installation of the guard devices 10 on compact discs 14 can be packaged for sale.

The application of the guard device 10 begins with placement of a conventional compact disc 14 on the locator pin portion 30 of the jig 12. The guard device 10 with its two peripheral beads of adhesive 22 is removed from the waxed liner sheet 20 and placed on the compact disc 14 with the aid of the locator pin portion 30 for exact placement. The waxed liner sheet 20 is pressed down manually to seat the guard device 10 exactly on the compact disc 14, whereby the guard device 10 is positioned accurately on the compact disc 14. It should be noted that the guard device 10 can be removed from the compact disc 14 without damaging it by suitable solvents.

It is to be understood that the present invention is not limited to the embodiment described above, but encompasses any and all embodiments within the scope of the following claims.

I claim:

1. A translucent compact disc surface guard device comprising:
a translucent, planar sheet of a plastic selected from the group consisting of acrylic, polyethylene and polycarbonate; and
said plastic sheet having a circular periphery, a centered circular aperture commensurate in size to a conventional compact disc, and a thickness of 0.005 to 0.010 inch;
whereby a compact disc can have its recorded surface protected by covering it with the translucent plastic sheet, and still be playable in a compact disc player device.

2. The guard device according to claim 1, wherein the plastic composition is acrylic.

3. The guard device according to claim 1, wherein the plastic composition is polyethylene.

4. The guard device according to claim 1, wherein the plastic composition is polycarbonate.

5. A method for covering a compact disc with a transparent surface guard comprising:
placing a conventional compact disc on a platform of a jig having a protruding center pin portion which abuts the center opening of the compact disc;
placing a translucent diecut planar plastic cover having a thickness of 0.005 to 0.010 inch, the same geometrical and size configuration as the compact disc, and having an outer and inner peripheral ring of adhesive on the plastic cover; and
pressing down manually on the cover with its adhesive to seat it on the compact disc;
whereby the plastic cover is positioned accurately on the compact disc.

6. The method according to claim 5, wherein a sheet of waxed paper is utilized to cover the plastic cover having the inner and outer peripheral rings of adhesive for packaging purposes.

7. The method according to claim 5, wherein the plastic cover is made of acrylic.

8. The method according to claim 5, wherein the plastic cover is made of polyethylene.

9. The method according to claim 5, wherein the plastic cover is made of a polycarbonate.

10. A device for placing a removable surface guard accurately on a compact disc comprising:
a plastic base having a centered pin portion having a diameter which snugly accepts the aperture of a compact disc; and
said pin portion projecting from a substantially planar top surface;
whereby a compact disc can be accurately covered with a protective surface guard.

11. The device according to claim 10, wherein the square base is hollow having a substantially open bottom, a centered cylindrical inner wall extending from top to bottom of the base and being open on top and the bottom of the base, and the inner wall having a series of equidistantly spaced peripheral keyholes on its inside surface.

12. The device according to claim 11, wherein the pin portion of the device comprises a removable cylindrical insert portion having a cylindrical compartment open at its bottom to include a circular foam sponge element.

13. The device according to claim 12, wherein the removable insert portion further includes external circular keys to cooperate with the peripheral keyholes in the inside surface of the centered cylindrical inner wall of the base to secure the insert portion in the base.

14. The device according to claim 10, wherein the device is formed by injection molding.

15. The device according to claim 10, wherein the device is made of phenolic resin.

16. The device according to claim 10, wherein the device is packaged with a plurality of compact disc surface guard devices having a thickness range of 0.005 to 0.010 inch each, and mounted on individual glued waxed paper liners.

17. The device according to claim 16, wherein the compact disc surface guard devices are translucent diecut planar acrylic covers.

18. The device according to claim 16, wherein the compact disc surface guard devices are translucent diecut planar polyethylene covers.

19. The device according to claim 16, wherein the compact disc surface guard devices are translucent diecut planar polycarbonate covers.

20. The device according to claim 16, wherein the package includes instructions on how to place a compact surface guard on a compact disc.
